(19) United States
(12) Patent Application Publication
(10) Pub. No.: US 2025/0319589 A1
(43) Pub. Date: Oct. 16, 2025

(54) UNDERBODY FRAME EQUIPMENT AND ROBOTIC CONFIRMATION EQUIPMENT PRIOR TO PROTOTYPE SHEET METAL PARTS

(71) Applicant: TOYOTA MOTOR ENGINEERING & MANUFACTURING NORTH AMERICA, INC., Plano, TX (US)

(72) Inventors: Huey Do, Walton, KY (US); Timothy S. Callison, Georgetown, KY (US); Kristopher M. Kidder, Lexington, KY (US); James D. Kowcheck, Verona, KY (US); Erwin Ruczienski, Walton, KY (US); Antonio Ortiz, JR., Georgetown, KY (US)

(73) Assignees: TOYOTA MOTOR ENGINEERING & MANUFACTURING NORTH AMERICA, INC., Plano, TX (US); TOYOTA JIDOSHA KABUSHIKI KAISHA, Aichi-ken (JP)

(21) Appl. No.: 18/633,231

(22) Filed: Apr. 11, 2024

(51) Int. Cl. B25J 9/16; B62D 65/02

(52) U.S. Cl. CPC B25J 9/1656; B62D 65/024

(57) ABSTRACT

The systems, devices, and methods described herein relate to validation of vehicle data using a validation body. This validation body may include 3D printed portions including a 3D printed base formed using vehicle data representing the underside of the vehicle, a tubular frame, and vehicle panels removably mounted on the tubular frame. The validation body may be used to validate vehicle data before a prototype vehicle is available. In some implementations, the validation body is formed from ABS reinforced with carbon fiber. Sealant lines may be machined into the validation body representing the sealant lines between parts on the vehicle.

### TECHNICAL FIELD

The present application is related to the production of motor vehicles, and more specifically, to systems, methods, and devices for validating manufacturing equipment used for prototyping motor vehicle parts.

### BACKGROUND OF THE DISCLOSURE

The mass production of a motor vehicle requires the use of various pieces of equipment. As examples, equipment may be used to move the motor vehicles through a manufacturing facility and robotics may be used for various functions during of vehicle production. In addition, structures that support the motor vehicle while manufacturing processes are conducted are used. When a new vehicle is to be mass produced, these pieces of equipment must be adapted to the design of the new vehicle. This adaptation may require validating both equipment and models before production of a vehicle can begin.

Existing validation systems are limited in their ability to validate vehicle data before prototyping. For example, validation systems formed out of cut foam may be used for validating the general size and weight of a vehicle model. However, these systems lack the ability to validate much of the vehicle data, including surface information, the position of various components above a vehicle base, and weight distribution.

Therefore, needs exist for methods for more accurate validation of manufacturing equipment for the production of a motor vehicle.

### SUMMARY

In some exemplary aspects, the present disclosure introduces a validation system for validating a vehicle design, that may include: a 3D printed base modeled on vehicle data representing an underside of a vehicle; one or more 3D printed sections modeled on vehicle data representing parts of the vehicle, the 3D printed sections rigidly attached to the 3D printed base; a tubular frame rigidly attached to the 3D printed base, the tubular frame comprising a plurality of tubular members attached together in a weight-bearing structure; and one or more door panels attached to the tubular frame, the door panels modeled on the vehicle data representing door panels of the vehicle.

In some implementations, the one or more door panels are 3D printed. The one or more door panels may be removably attached to the tubular frame, such that the one or more door panels are configured to break away from the tubular frame in the event of a collision with a robot. The one or more door panels may include a front windshield, a front door, and a rear door. The 3D printed base may include a plurality of sealant lines. The sealant lines may be machined into a surface of 3D printed material of the 3D printed base. In some implementations, a surface of the 3D printed base is sufficient detailed such that it is suitable for training a computer vision system. The 3D printed base may include channels sized to accommodate a rocker panel. The 3D printed base may be formed from acrylonitrile butadiene styrene (ABS) reinforced with carbon fiber.

The present disclosure also introduces a method for validating a vehicle design using a validation body, which may include: identifying 3D data based on a desired vehicle design and 3D data associated with the desired vehicle design; preparing the identified 3D data for 3D printing by eliminating unnecessary data and modifying surfaces to make them suitable for 3D printing; 3D printing validation parts using the identified and prepared 3D data, the validation parts including a 3D printed base representing an underside of the desired vehicle design; assembling the 3D printed validation parts into a validation body; measuring datum point positions on the validation body; machining lines into the validation body to visualize teaching paths for a computer vision (CV) process; and validating data for producing prototype vehicle parts using the validation body.

In some implementations, the method includes printing validation parts including vehicle panels. The method may include assembling the 3D printed validation parts and a tubular frame into the validation body. The method may include assembling the 3D printed validation parts including vehicle frames onto the tubular frame to form the validation body. The method may include removably attaching the vehicle frames to the tubular frame such that in the event of a collision, the vehicle frames break away from the tubular frame. The step for machining lines into the validation body may include machining sealant lines into the 3D printed base.

The present disclosure also introduces a validation body for validating a vehicle design, which may include: a 3D printed base modeled on vehicle data representing an underside of a vehicle, the 3D printed base comprising acrylonitrile butadiene styrene (ABS) reinforced with carbon fiber, wherein the 3D printed base includes: a plurality of sealant lines machined into the 3D printed base; a plurality of datum points; and a rocker panel that is disposed within channels in the 3D printed based sized to fit the rocker panel; and a plurality of 3D printed sections modeled on vehicle data representing parts of the vehicle, the 3D printed sections rigidly attached to the 3D printed base.

In some implementations, a tubular frame is rigidly attached to the 3D printed base, the tubular frame comprising a plurality of tubular members attached together in a weight-bearing structure. One or more vehicle panels may be included that are modeled on the vehicle data representing panels of the vehicle. The one or more vehicle panels may be removably attached to the tubular frame such that in the event of a collision, the one or more vehicle panels break are arranged to break away from the tubular frame. The one or more vehicle panels may include a windshield panel, a front door panel, and a rear door panel.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a diagram of a foam underbody.

FIG. 2 is a perspective view of a validation body according to embodiments of the present invention.

FIG. 3A is a perspective view of the validation body according to embodiments of the present invention.

FIG. 3B is a view of the underside of the validation body according to embodiments of the present invention.

FIG. 3C is a view of the rear of the validation body according to embodiments of the present invention.

FIG. 3D is a view of the side of the validation body according to embodiments of the present invention.

FIG. 4A is a perspective view of prototype vehicle door frames according to embodiments of the present invention.

FIG. 4B is a perspective view of prototype vehicle door frames according to embodiments of the present invention.

FIG. 5 is a view of the underside of the validation body with sealer lines according to embodiments of the present invention.

FIG. 6 is a perspective view of side portions of the validation body according to embodiments of the present invention.

FIG. 7 is a diagram illustrating a robot arm passing through the vehicle door frames according to embodiments of the present invention.

FIG. 8 is a flowchart illustrating a method for assembling the validation body and validating vehicle data according to embodiments of the present disclosure.

### DETAILED DESCRIPTION

The present disclosure describes devices, systems, and methods for validating manufacturing equipment for the production of a motor vehicle. In particular, the present disclosure provides for an adjustable validation body with 3D-printed portions for validating vehicle manufacturing equipment.

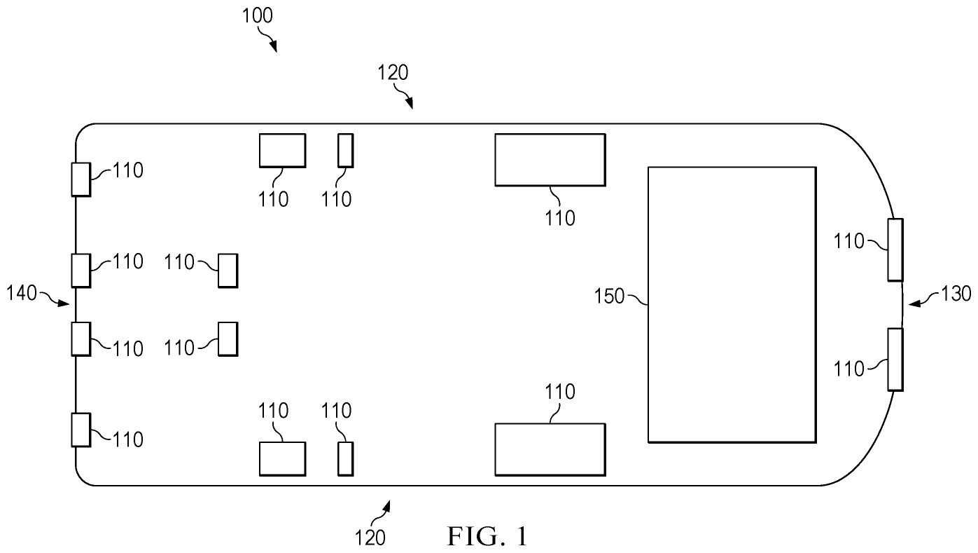

In some implementations, a three-dimensional model of certain portions of a vehicle is finalized before a physical confirmation vehicle is produced. A validation body with 3D printed portions may be produced using the three-dimensional model of the vehicle well before a confirmation vehicle can be produced. Accordingly, this validation body may be used to validate manufacturing equipment before the production of a confirmation vehicle. This validation may include measuring the precise center of gravity of a validation body representing actual vehicle data (which may be accomplished using conveyance equipment such as lifters, hangers, and dollies) as well as teaching processes for automation application equipment using accurate representation of 3D vehicle data. Using this type of validation body to validate manufacturing equipment may expedite the process of preparing a manufacturing facility for the production of a new vehicle, by allowing the validation process to begin before the production of a confirmation vehicle is complete. According to the implementation of the present disclosure, this three-dimensional model may include a 3D printed validation body that offers a number of improvements over other systems, such the machined foam underbody 100 shown in FIG. 1.

The machined foam underbody 100 of FIG. 1 includes touchpoints 110 that have been machined into the foam underbody to correspond with touchpoints from the three-dimensional model of the underbody of the vehicle. The touchpoints 110 of the foam underbody 100 are generally high wear areas. At least one of the touchpoints 110 of the foam underbody 100 may be machined out of a dense foam or a metal to form an insert. These dense foam or metal inserts may then be inserted into the foam underbody 100 at the position of the corresponding touchpoint 110.

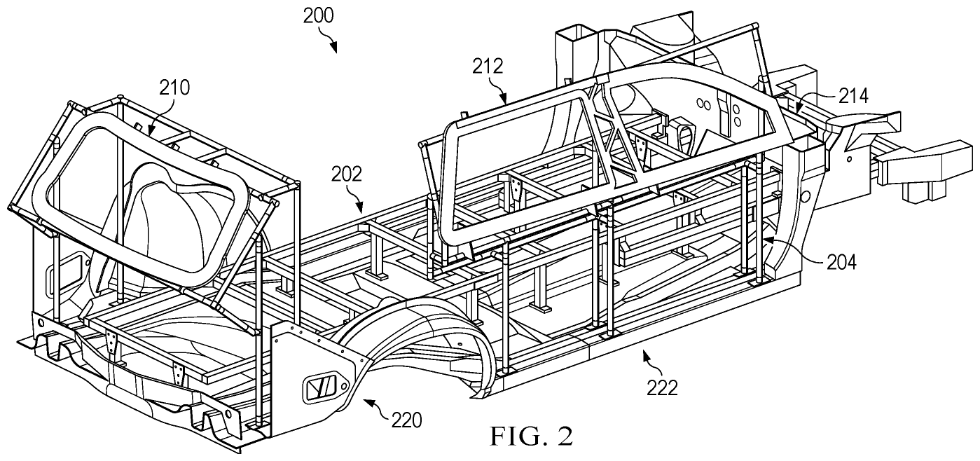

In contrast to the machined foam underbody 100, FIG. 2 shows a validation body (or early confirmation body) 200 that includes a frame 202, tube structure 204, and vehicle frames 210, 212, 214. In some implementations, the frame 202 is formed from a 3D printed material such as acrylonitrile butadiene styrene (ABS) reinforced by carbon fiber. This material may be more durable than existing validation systems using foam or other materials that are more brittle or easily gouge or scrape. In particular, this reinforced ABS may minimize damage from contact with machinery such as forklifts during transportation of the validation body 200.

The frame 202 may be 3D printed based on portions of a three-dimensional model of a vehicle. For example, the three-dimensional model may be a computerized model created in any suitable three-dimensional modeling program or application. In embodiments, the three-dimensional model includes information including dimensions of the components making up the underbody, frame, door panels, and other portions of a vehicle. The three-dimensional model may further include information or data on the mass of the underbody of the vehicle and the center of gravity of the vehicle. Further, the frame 202 may comprise underbody data from the three-dimensional model of the vehicle. The frame 202 may be configured to facilitate transportation of the validation body 200 and accordingly, may be stiff enough to bear the weight of the tube structure 204 and vehicle frames 210, 212, 214 during transportation. The validation body 200 may include a channel 222 that is sized to accommodate a rocker panel or other vehicle support structure. In some implementations, the rocker panel is included on the validation body 200 assembly and used during transportation of the validation body 200 to provide additional rigidity.

The validation body 200 may also comprise a tube structure 204 connected to the frame 202. In some implementations, the tube structure 204 is formed from round tubes for ease of fabrication. The tube structure 204 may be formed from metal tubes. The tube structure 204 may be configured to model the side and rear panels of the vehicle and may be connected to the frame 203 via screws or bolts. The tube structure 204 may support vehicle frames 210, 212, 214 representing the windshield, front, and rear doors of the vehicle, respectively. In some implementations, the vehicle frames 210, 212, 214 are based on the three-dimensional vehicle model and may represent the shape of the actual vehicle. The vehicle frames 210, 212, 214 may be configured to break away from the tube structure 204 in the case of inadvertent contact, such as by a robot used for assembly or scanning purposes. For example, the vehicle frames 210, 212, 214 may be formed with a thin width (in some implementations, less than 6 mm) to facilitate the break-away function. This may help to avoid damage to the validation body 200 as well as to the robot.

The frame 202 may provide flexibility in how weight is distributed on the validation body 200. For example, weight may be added to different portions of the frame 202 to represent various types of vehicles, such as conventional gas, hybrid, plug in hybrid, and electric battery vehicles. Further, the center of gravity of the entire validation body 200 may be changed using the weighting of the tube structure. This may accommodate different centers of gravity for different vehicle types. The flexibility to change the weight distribution through the use of various weight positions provides an advantage over other fixed validation systems where weight distribution could not be changed.

In some implementations, the frame 202 allows for easy transportation of the validation body 200 by providing unlimited touch points and multiple pick up positions. In particular, the frame 202 may include overhead pick up points for locations where direct forklift access is not feasible.

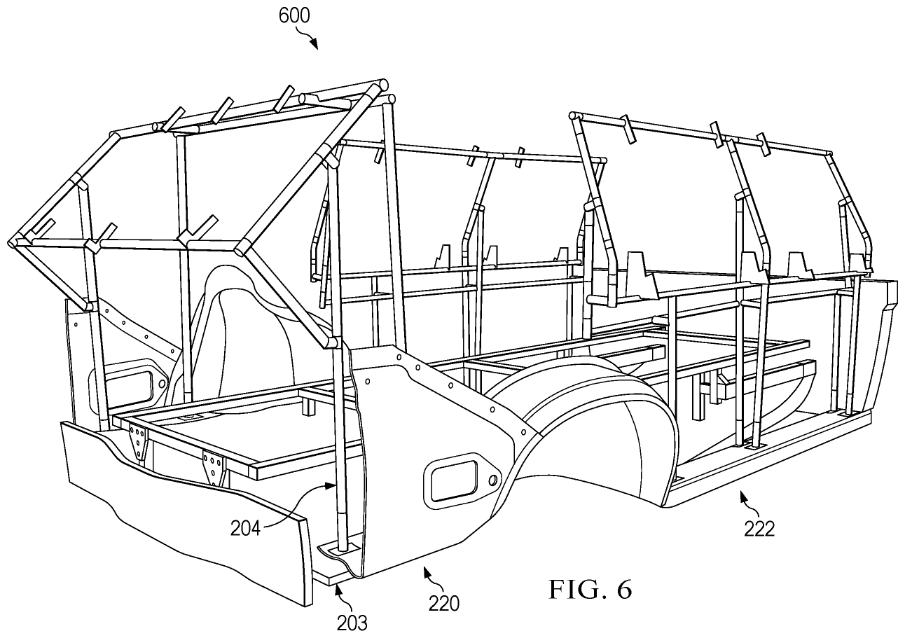

The validation body 200 may also include small part portions 220 which may also be 3D printed. These portions 220 may facilitate vision system recognition and may be used for automation processing and utilize software to adjust teaching. For example, FIG. 6 shows a small part portion 220 which may be mounted to the frame 203 and tube structure. This small part portions 220 may accurately represent the 3D vehicle data (such as on a side panel as shown in the example of FIG. 6, although other portions of the vehicle may be represented) and may be used to train a vision system. Examples of parts that may be represented by the small part portions 220 include front wheel arch areas and suspension mount holes.

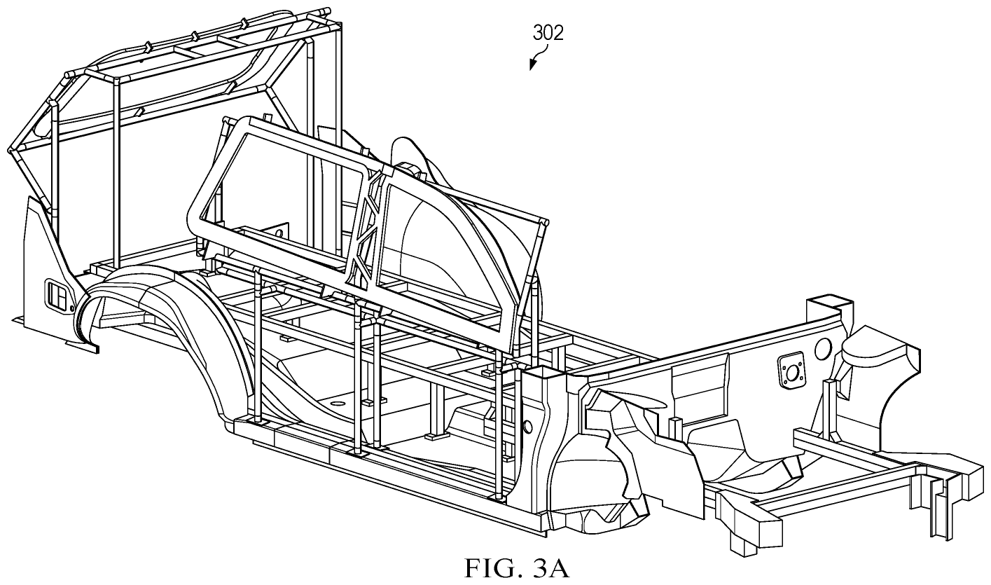

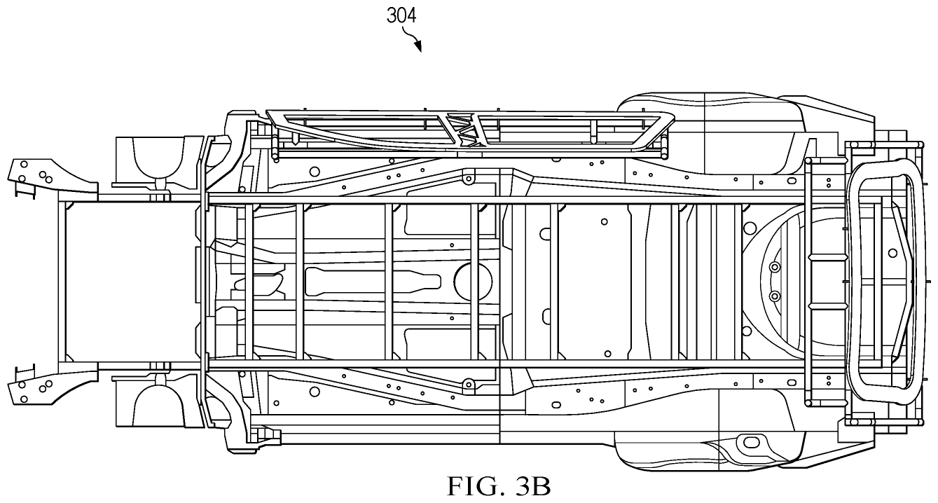

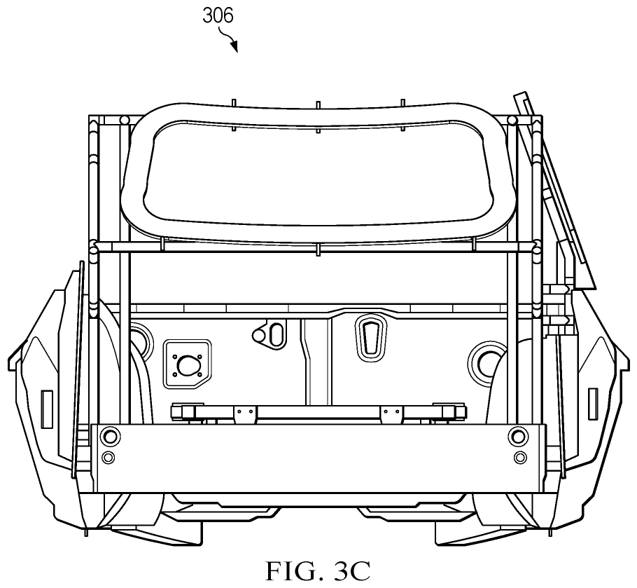

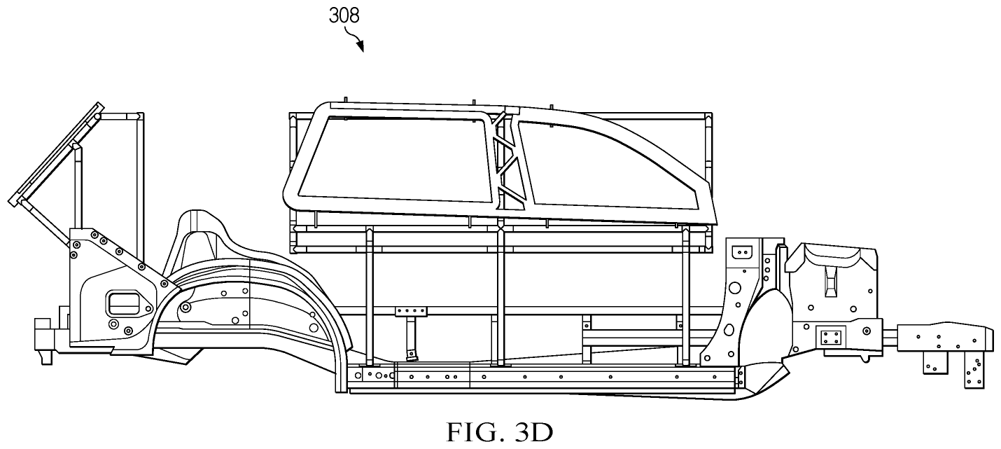

FIGS. 3A-3D includes various perspective views of the validation body 200, for example an isometric perspective view 302, an overhead perspective view 304, a front perspective view 306, and a side perspective view 308.

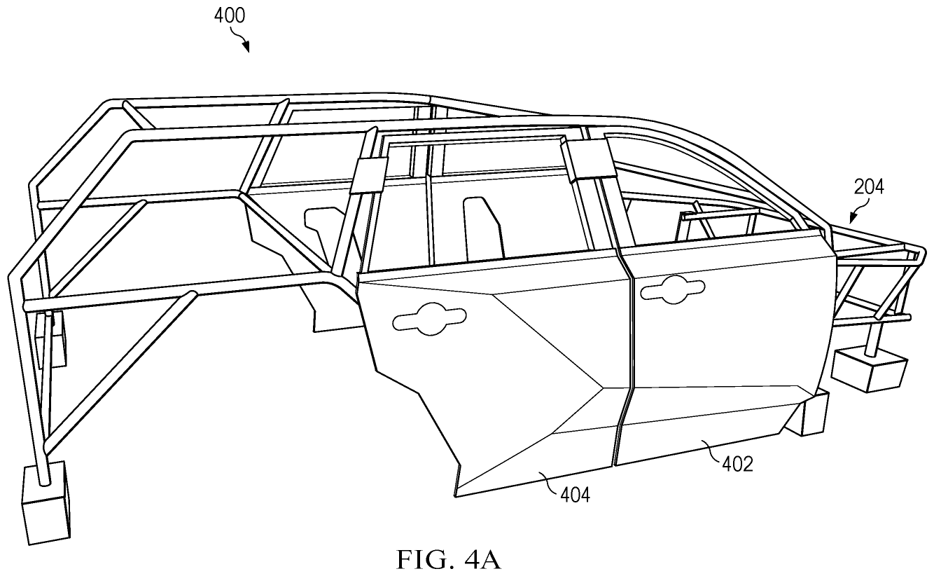

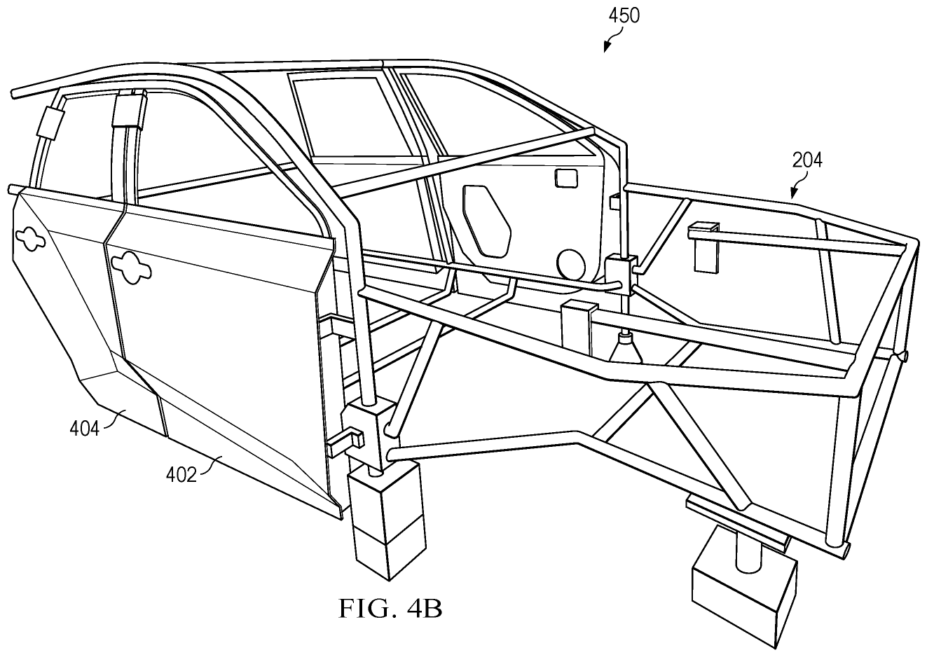

In some implementations, the validation body 200 includes full door panels 402, 404 such as shown in diagram 400 of FIG. 4A and diagram 450 of FIG. 4B. These door panels 402, 404 may be formed based on the 3D vehicle design. In some implementation, the door panels 402, 404 are formed from resin. The door panels may also include machined or 3D printed portions. In some implementations, the door panels 402, 404 are attached to the tubular structure 204 as shown in FIGS. 4A and 4B. Similar to the vehicle frames 210, 212, 214, the door panels 402, 404 may be designed to break away from the validation body 200 or otherwise deform upon contact to avoid damaging a robot as well as the validation body 200. The door panels may be made with a thickness sufficiently thin to allow for this break away function. This represents an improvement over current systems, in which contact which frequently occurs between a robot and the validation body causes damage to either the robot or the validation body.

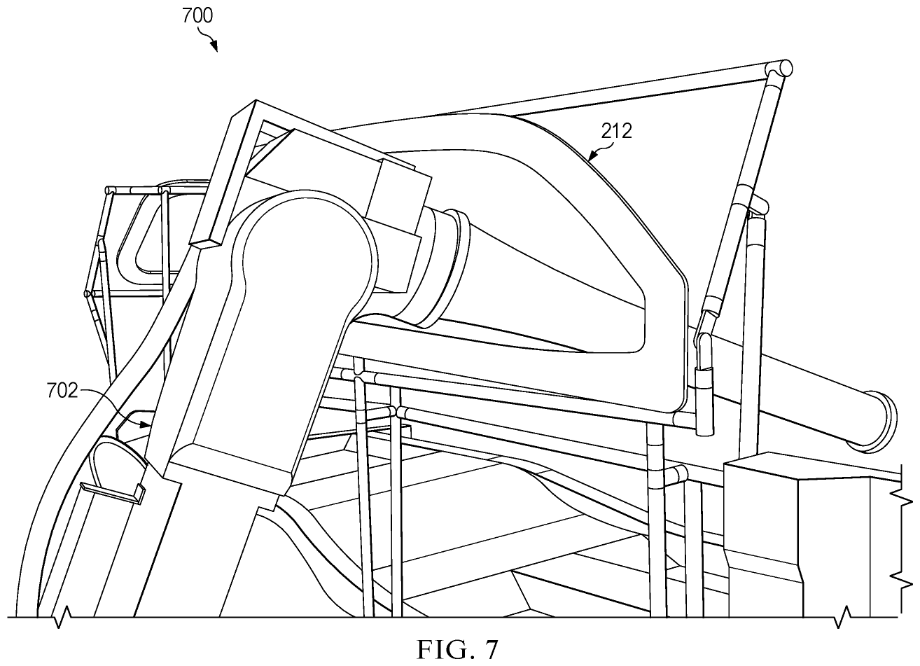

In some implementations, the vehicle frames 210, 212, 214 and door panels 402, 404 may be used for validation purposes, such as allowing a robot 702 to reach through the vehicle frames 210, 212, 214 or door panels 402, 404 as shown in the diagram 700 of FIG. 7. This may provide for a new level of confirmation not provided by current validation techniques and may ultimately speed up production times by allowing a physical check on the fit of the robot within the vehicle before a prototype is available.

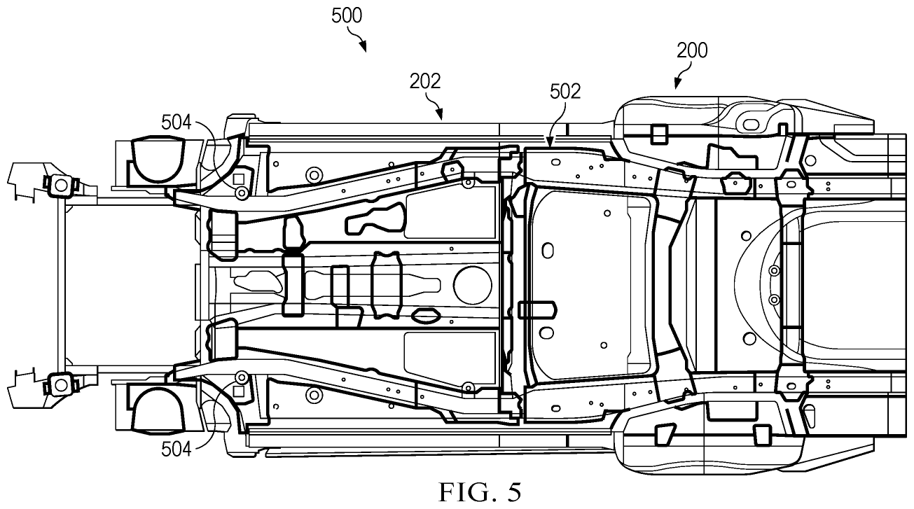

FIG. 5 shows the bottom side of the validation body 200 which may include machined lines (which may include sealer lines 502). These lines may represent gaps between the various metal parts on the vehicle prototype, and may be later filled with sealant on the finished vehicle. The machined lines may be disposed on the underside of the validation body 200 as well as on the interior floor side. In some implementations, the sealer lines 502 are machined into the frame 202. This may provide for more accurate details than possible using previous foam construction materials, and may allow for the use of computer vision systems not available in previous validation techniques. In some implementations, the machined sealer lines 502 are accurate to the 3D data within 2 mm from design data. This may represent a significant improvement over currently available systems, where body accuracy of sealer lines may have up to 6-8 mm of discrepancy when compared to 3D design data. In some implementations, the machined lines are used for initial teaching and spray applications are further added to the validation body 200 to further confirm actual vehicle body data.

The validation body 200 may also include datum points 504 which may be used to define weight bearing areas on the frame 202. The increased accuracy of the validation body 200 (both as a function of the accuracy to the vehicle design provided by 3D printing as well as the ability to 3D print much smaller structures than possible using foam or other materials) may decrease the number of required teaching cycles for validation, which leads to increases in productivity. In some cases, the increased accuracy and new validation techniques available with the validation body 200 as disclosed herein may speed up production by 5-6 months, as well as providing improvements in the quality of prototype vehicles and reducing costs associated with vehicle production.

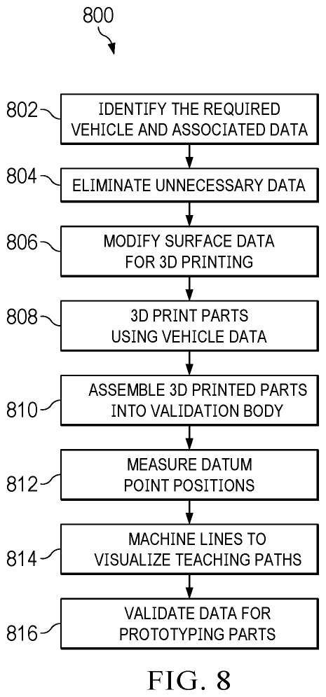

FIG. 8 shows a method 800 for assembling a validation body and validating vehicle data according to implementations in the present disclosure. The validation body may be the validation body 200 described in FIGS. 2-7.

The method 800 may include block 802 to identify the required vehicle and associated data. In some implementations, the required vehicle is scheduled for production and the associated data includes 3D data required to create a 3D printed prototype of vehicle parts. Block 802 may also include selecting portions of data for 3D printing parts. For example, identifying which parts can be separately 3D printed in small parts for more efficient processing.

In block 804, the method 800 may include eliminating unnecessary data from the vehicle data. This data may include structures that are not critical to trial and teaching processes, such as various internal structures. This block 804 may also include eliminating duplicate overlapping digital data. Necessary data may include the underside of the vehicle (and in particular the data used to 3D print the frame 202), small part portions 220, and vehicle frames 210, 212, 214 or door panels 402, 404 as discussed previously.

In block 806, the method 800 may include modifying surface data for 3D printing. This may include modifying surface data that is not able to be 3D printed due to part angle surface (such as overhanging surfaces). This modification also includes selecting appropriate surface textures and shapes for validation purposes.

In block 808, the method 800 may include 3D printing parts using the vehicle data developed in the previous blocks. In some implementations, the 3D printing of parts is carried out using the most efficient processing method. For example, a portion of the 3D vehicle data may be printed in any number of sections, such as 1, 2, or 3 sections depending on complexity. For a 1 section print, high print time may be used which may reduce assembly time, whereas a 2 section print may have a lower print time but higher assembly time, and a 3 section print may have an even lower print time. Detailed portions with a high print time may also be selected for detailed portions of the validation body.

In block 810, the method 800 may include assembling the 3D printed parts with other components into a validation body. In some implementations, this block 810 may include 3D printing and assembling a frame 202 (which may include various small part portions 220) with a tubular structure 204, as well as adding vehicle frames 210, 212, 214 or full door panels 402, 404. Other parts may also be added to the validation body, such as other door frames or panels. These components may be assembled using bolts, screws, adhesives, welding, or otherwise fixed together mechanically. In some implementations, the tubular structure 204 is attached to the frame 202 before the door panels are attached to the tubular structure 204. In some implementations, the door frames or panels may be removably attached to the tubular structure 204 and frame 202 such that they may break away if they are contacted by a robot or other equipment. This may avoid damage to machinery or other portions of the validation body.

In block 812, the method 800 may include measuring datum point positions. The datum point positions may be determined based on vehicle data representing weight bearing areas of the vehicle.

In block 814, the method 800 may include machining lines to visualize teaching paths. This block 814 may include modifying the validation body, such as by machining sealer lines into the frame 202. The machining lines may be selected to represent the intersections of various parts. Accordingly, the validating body may be fully prepared for validating vehicle data ahead of forming a prototype vehicle. The accuracy of machined lines may be checked using laser measuring devices.

In block 816, the method 800 may include validating data for prototyping parts. This may include conducting a validating process on the validation body, for example, loading and unloading the validation body 200 onto equipment such as lifters, carriers, or dollies. This validation may also include confirming prototype equipment changes with the validation body 200 before an actual confirmation vehicle arrives on site, as well as producing more prototype equipment in order to be ready for the arrival of the confirmation vehicle. Validation may also include robot teaching and spray application to confirm digital teaching is correct prior to the actual arrival of the confirmation vehicle on site. In some cases, the validation body 200 can be utilized for team member confirmation of some of the sealer line area for reach access and ergonomic assessment.

The foregoing outlines features of several implementations so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the implementations introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72 (b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. § 112 (f) for any limitations of any of the claims herein, except for those in which the claim expressly uses the word “means” together with an associated function.

What is claimed is:

1. A validation system for validating a vehicle design, comprising:
a 3D printed base modeled on vehicle data representing an underside of a vehicle;
one or more 3D printed sections modeled on vehicle data representing parts of the vehicle, the 3D printed sections rigidly attached to the 3D printed base;
a tubular frame rigidly attached to the 3D printed base, the tubular frame comprising a plurality of tubular members attached together in a weight-bearing structure; and
one or more door panels attached to the tubular frame, the door panels modeled on the vehicle data representing door panels of the vehicle.

2. The validation system of claim 1, wherein the one or more door panels are 3D printed.

3. The validation system of claim 1, wherein the one or more door panels are removably attached to the tubular frame, such that the one or more door panels are configured to break away from the tubular frame in the event of a collision with a robot.

4. The validation system of claim 1, wherein the one or more door panels comprise a front windshield, a front door, and a rear door.

5. The validation system of claim 1, wherein the 3D printed base comprises a plurality of sealant lines.

6. The validation system of claim 5, wherein the sealant lines are machined into a surface of 3D printed material of the 3D printed base.

7. The validation system of claim 1, wherein a surface of the 3D printed base is sufficient detailed such that it is suitable for training a computer vision system.

8. The validation system of claim 1, wherein the 3D printed base comprises channels sized to accommodate a rocker panel.

9. The validation system of claim 1, wherein the 3D printed base comprises acrylonitrile butadiene styrene (ABS) reinforced with carbon fiber.

10. A method for validating a vehicle design using a validation body, comprising:
identifying 3D data based on a desired vehicle design and 3D data associated with the desired vehicle design;
preparing the identified 3D data for 3D printing by eliminating unnecessary data and modifying surfaces to make them suitable for 3D printing;
3D printing validation parts using the identified and prepared 3D data, the validation parts including a 3D printed base representing an underside of the desired vehicle design;
assembling the 3D printed validation parts into a validation body;
measuring datum point positions on the validation body;
machining lines into the validation body to visualize teaching paths for a computer vision process; and
validating data for producing prototype vehicle parts using the validation body.

11. The method of claim 10, further comprising 3D printing validation parts including vehicle panels.

12. The method of claim 11, further comprising assembling the 3D printed validation parts and a tubular frame into the validation body.

13. The method of claim 12, further comprising assembling the 3D printed validation parts including vehicle frames onto the tubular frame to form the validation body.

14. The method of claim 13, further comprising removably attaching the vehicle frames to the tubular frame such that in the event of a collision, the vehicle frames break away from the tubular frame.

15. The method of claim 10, wherein the step for machining lines into the validation body comprising machining sealant lines into the 3D printed base.

16. A validation body for validating a vehicle design, comprising:
a 3D printed base modeled on vehicle data representing an underside of a vehicle, the 3D printed base comprising acrylonitrile butadiene styrene (ABS) reinforced with carbon fiber, wherein the 3D printed base comprises:
a plurality of sealant lines machined into the 3D printed base;
a plurality of datum points; and
a rocker panel that is disposed within channels in the 3D printed based sized to fit the rocker panel; and
a plurality of 3D printed sections modeled on vehicle data representing parts of the vehicle, the 3D printed sections rigidly attached to the 3D printed base.

17. The validation body of claim 16, further comprising a tubular frame rigidly attached to the 3D printed base, the tubular frame comprising a plurality of tubular members attached together in a weight-bearing structure.

18. The validation body of claim 17, further comprising one or more vehicle panels modeled on the vehicle data representing panels of the vehicle.

19. The validation body of claim 18, wherein the one or more vehicle panels are removably attached to the tubular frame such that in the event of a collision, the one or more vehicle panels break are arranged to break away from the tubular frame.

20. The validation body of claim 18, wherein the one or more vehicle panels comprise a windshield panel, a front door panel, and a rear door panel.
